(19) United States
(12) Patent Application Publication
(10) Pub. No.: US 2006/0058044 A1
(43) Pub. Date: Mar. 16, 2006

(54) Mobile station repaging method and apparatus

(75) Inventors: Robert Horvath, Arlington Heights, IL (US); Thomas B. Hart, West Dundee, IL (US)

Correspondence Address: MOTOROLA, INC., 1303 EAST ALGONQUIN ROAD, IL01/3RD, SCHAUMBURG, IL, 60196, US

(73) Assignee: Motorola, Inc.

(21) Appl. No.: 10/940,373

(22) Filed: Sep. 14, 2004

(51) Int. Cl. H04Q 7/20

(52) U.S. Cl. 455/456.5; 455/456.1

(57) ABSTRACT

A system controller (10) having a first mode of operation to repage a wireless mobile station in a multi-zone wireless communication system (11). The system controller (10) accesses a location register (12) to obtain a zone location corresponding to a wireless mobile station. The system controller (10) then uses the transmission resources of the zone location to facilitate sourcing a wireless communication with the wireless mobile station. If the wireless mobile station does not respond, the first mode of operation for repaging the wireless mobile station includes the system controller's (10) accessing the location register (12) to obtain a second zone location and using the transmission resources of only the second zone location to source a wireless communication to the wireless mobile station.

### TECHNICAL FIELD

This invention relates generally to wireless communication systems and more particularly to systems that initiate communications to wireless mobile stations by repaging in one or more zones of operation.

### BACKGROUND

Wireless communication systems of various kinds are known in the art. Many such systems typically include a method and apparatus to locate a mobile station and establish a wireless communications link between the mobile station and a telecommunications network. To facilitate such a process, many such systems typically include a location register that registers one or more previous zone locations where a given mobile station was previously located.

Once there is a need to locate a mobile station, certain previous systems access the location register to determine the last registered zone for the mobile station. The system will then page the mobile station using the transmission resources of the last reported zone in an attempt to establish a communications link. The mobile station, however, may not respond to that initial attempt.

Many reasons explain why a mobile station may not respond to an initial page from the system. The mobile station may have moved out of its last reported zone and did not update its location register prior to the system's initial page. For example, the mobile station may be located along a seam between zones, moving back and forth between the zones. Also, the mobile station may have faded or otherwise momentarily lost coverage within the original zone.

Therefore, in a second attempt to reach the mobile station, certain existing wireless communications systems will repage or send a second page using the transmission resources of the last reported zone and simultaneously the transmission resources of all zones surrounding the last reported zone. This method of essentially reaching out to as many possible zones as possible when repaging to locate and establish a communications link with the mobile station will often overly burden such a system with paging capacity problems. This, in turn, can impact overall quality of service in a negative fashion.

### BRIEF DESCRIPTION OF THE DRAWINGS

The above needs are at least partially met through provision of the mobile station repaging method and apparatus described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention; and

FIG. 3 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a need to locate a given wireless mobile station with respect to a multi-zone wireless communication system is determined. In response, a system controller automatically accesses a location register to obtain a first zone location corresponding to the wireless mobile station. Then, using the first zone location, the system controller facilitates sourcing a wireless communication to the wireless mobile station. If the system controller determines that the wireless mobile station did not respond to the attempted communication, the system controller in response automatically accesses the location register to obtain a second zone location corresponding to the wireless mobile station. Using the second zone location, the system will again facilitate sourcing a wireless communication.

By using the second zone location for the later attempt instead of all the zone locations neighboring the first zone location, the system avoids overburdening its communication resources while also often successfully establishing the desired communication.

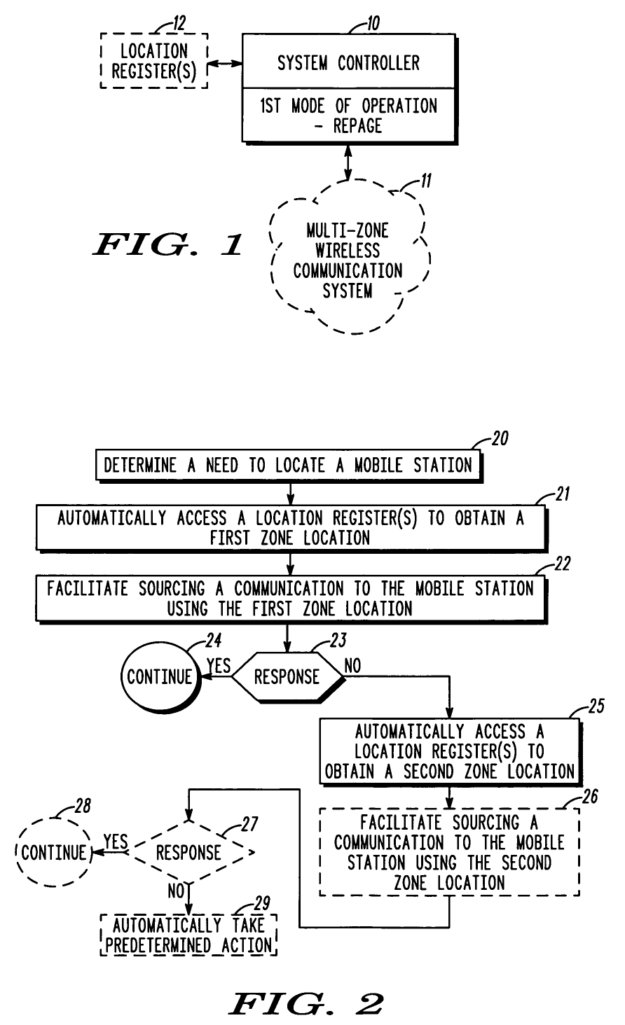

Referring now to the drawings and in particular to FIG. 1, a system controller 10 for use in a multi-zone wireless communication system 11 includes an interface with a location register 12 and has at least a first mode of operation such that a repage communication to a given mobile station can be sourced using only the transmission resources of a single zone. One should note that the location register 12 can be physically located either separately from the system controller 10 or within the system controller 10 as suggested by the illustration.

The first mode of operation for repaging in accordance with the various embodiments of the invention will now be described with reference to FIG. 2. The system controller 10 will first determine 20 a need to locate a given wireless mobile station with respect to the multi-zone wireless communication system 11. An example of a multi-zone wireless communication system 11 is a geographically distributed resource reuse wireless communication system, although the embodiments of this invention may be used in connection with any suitable multi-zone wireless communication system such as a frequency division multiple access system, a time division multiple access system, a code division multiple access system, and other compatible variations as known in the art. It should also be noted that the wireless mobile station can be a wireless telephony device.

As such, various reasons can create a need to locate the given wireless mobile station. For example, the system controller 10 may need to facilitate an audio wireless communication. An audio wireless communication may include voice communications between the wireless mobile station, such as a wireless telephony device, and another telephony device. The system controller 10 may also need to facilitate a wireless packet data communication. Alternatively, the system controller 10 may need to facilitate a wireless short message service such as text messaging. Another example demonstrating a need to locate the wireless mobile station includes where the system controller 10 may need to facilitate emergency services-based location tracking.

Once the system controller 10 determines the need to locate the wireless mobile station, the system controller 10 automatically accesses 21 the location register 12 to obtain a first zone location that corresponds to the given wireless mobile station. An example of a location register 12 is a visited location register (“VLR”). The VLR can be configured to store the most recent zone location, the last two zone locations, or any number of previous zone locations for a given wireless mobile station. In a typical embodiment of the invention, when the system controller 10 automatically accesses 21 the location register 12, the first zone location represents the last known zone location for the wireless mobile station. It should be noted also that the system controller 10 may, in certain embodiments, access more that one location register 12 to obtain zone locations. Such visited location registers are generally known in the art and require no further elaboration here.

After obtaining the first zone location, the system controller 10 uses the first zone location to facilitate sourcing 22 a wireless communication to the mobile station. To do so, the system controller 10 would typically use only the transmission resources of the first zone location to source the wireless communication.

Next, the system controller determines whether a response 23 is received from the wireless mobile station. Typically, the system controller 10 will wait a predetermined period of time, commonly called a timeout period, for the response 23. If the system controller 10 receives a response 23 within the timeout period, it continues 24 to fulfill the need for locating the wireless mobile station.

If the system controller 10 does not receive a response within the predetermined time period, the system controller 10 automatically accesses 25 the location register 12 to obtain a second zone location corresponding to the wireless mobile station. In the case where the wireless mobile station did not respond because it had moved to a new zone but had not yet registered its new zone location when the system obtained the first zone location, the second zone location would typically correspond to updated zone location information for the wireless mobile station. In other words, the second zone location would usually be different from the first zone location. On the other hand, if the wireless mobile station did not respond because it had faded or otherwise missed the transmission but did not change zones, the second zone location would be the same as the first zone location. For these embodiments in accordance with the first mode of operation such that a repage communication to a wireless mobile station is sourced using only a single zone's transmission resources, the system controller 10 would only obtain a single zone location from the location register 12 corresponding to the wireless mobile station. As at least one alternative, the system controller 10 could obtain multiple zone locations from the location register 12 and then utilize some selection criteria of choice to facilitate the use of only a single zone location to otherwise accord with this approach.

In other alternative embodiments, the system controller 10 in step 25 of FIG. 2 obtains a plurality of zone locations from the location register 12 when obtaining a second zone location. In these cases, the zone locations obtained from the location register 12 may include any number of the most recent zone locations stored therein corresponding to the given wireless mobile station. For instance, the system controller 10 may obtain the previous three zone locations for the wireless mobile station. In these cases, some but not all of the zones that neighbor the first zone location are obtained. In the case where the wireless mobile station is moving between two zone locations along a seam between the two, the system controller 10 can obtain the last two zone locations from the location register 12. In such embodiments, the second zone location includes all the zone locations obtained from the location register 12. In such embodiments, the provided zone locations represent some reasonable prior connection to the mobile station other than simply being a neighboring zone to a particular zone of prior interest.

After automatically accessing 25 a location register 12 to obtain a second zone location, the system controller 10 facilitates sourcing 26 a communication to the wireless mobile station using the second zone location. During this second attempt, the system controller will use only the transmission resources of the zone or zones corresponding to the second zone location. After attempting to source the communication as with the first attempt, the system controller 10 then determines 27 whether the wireless mobile station has responded. If the wireless mobile station responds 27 within a certain timeout period, the system controller 10 continues 28 to fulfill the need for locating the wireless mobile station. If the wireless mobile station does not respond 27 within a certain timeout period, the system controller 10 will then typically automatically take 29 a predetermined action.

The system controller 10 may take a variety of such predetermined actions. In one embodiment, the system controller 10 automatically accesses the location register 12 to obtain a supplemental zone location corresponding to the wireless mobile station. This embodiment would repeat the steps performed to obtain the second zone location, including any of the variations in doing so, to obtain the supplemental zone location.

In another embodiment the system controller 10 concludes the attempts to facilitate a wireless communication with the wireless mobile station after determining for a second time that there is no response. In such an embodiment, the system controller 10 will typically have waited through two timeout periods to determine that the wireless mobile station did not respond. If the timeout period is in the range of five to ten seconds, the system controller 10 will have waited for up to twenty seconds to source a communication to the wireless mobile station. If the reason to source the wireless communication was to facilitate an audio communication, the party initiating the communication will very likely have already ended the attempt after waiting for ten to twenty seconds. Thus, there is no need in this embodiment for the system controller 10 to continue to facilitate sourcing a communication to the wireless mobile station after two attempts without a response.

In yet another embodiment of the invention, after determining for a second time that there is no response, the system controller 10 automatically sources a subsequent wireless communication to the wireless mobile station by using the transmission resources of all neighbor zones for the second zone location. In this embodiment, the system controller 10 resorts to the method of certain prior systems but only after making two prior attempts using fewer than all the zones neighboring the first zone location.

In the preferred embodiment of the invention, a method to facilitate determining a present location of a given wireless mobile station in a multi-zone wireless communication system includes several steps. First, a need to locate the wireless mobile station within the multi-zone wireless communication system is determined. In response to determining the need to locate the wireless mobile station, a first location register is automatically accessed to obtain a first zone location corresponding to the wireless mobile station. Next, the first zone location is used to facilitate sourcing a wireless communication to the wireless mobile station using only the transmission resources of the first zone location. Then it is determined that the given wireless mobile station did not respond to the wireless communication. In response to determining that the given wireless mobile station did not respond, a second location register is automatically accessed to obtain a second zone location corresponding to the wireless mobile station. Next, the second zone location is used to facilitate sourcing a wireless communication to the wireless mobile station using only the transmission resources of the second zone location, such that neighbor zones to the second zone location are not utilized.

It should be noted that the second zone location may be the same as the first zone location. Also, although the first location register is preferably the same as the second location register, they may be different in some embodiments. One should also note that in the preferred embodiment the first and second location registers are visited location registers.

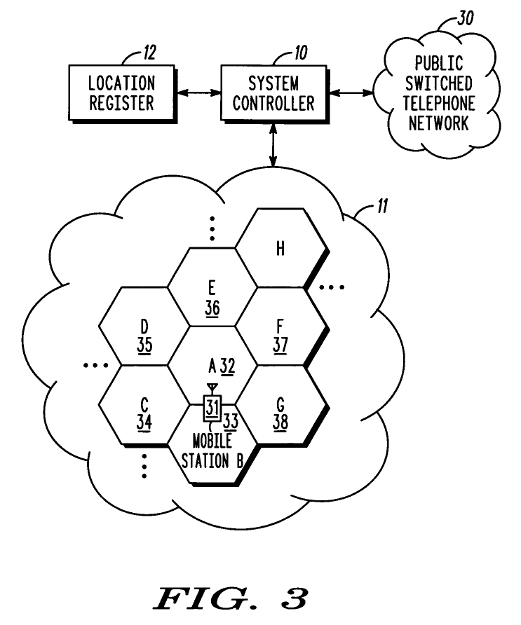

An illustrative example is demonstrated with reference to FIG. 3. In this example, the system controller 10 is a mobile switching center (“MSC”) for a multi-zone communication system 11 interfaced to a location register 12 and to a public switched telephone network 30. The MSC determines a need to locate the wireless mobile station 31 because of an attempt to place an audio communication with the mobile station 31 from the public switched telephone network 30. To do so, the MSC automatically accesses the location register 12 to obtain a first zone location for the mobile station 31. In this example, the last zone registered with the location register 12 is zone A 32 in the multi-zone communication system 11. Then, the MSC uses the transmission resources of zone A 32 to page the mobile station 31. However, because the mobile station 31 is moving between two zones, A 32 and B 33, it misses the page issued in zone A 32.

When the timeout period expires, the MSC determines that the mobile station 31 did not respond to the page. Thus, to repage the mobile station, the MSC automatically accesses the location register 12 to obtain a second zone location. In this example, the MSC obtains the last two zone locations from the location register 12. Because the mobile station 33 is moving between zone A 32 and zone B 33, the MSC will obtain these two zone locations from the location register 12. Then the MSC will use the transmission resources of only zone A 32 and zone B 33 to repage the mobile station 31.

Thus by accessing the location register 12 a second time before repaging, the MSC uses the transmission resources of only two zones during the repage in contrast to certain prior systems that would have automatically repaged the mobile station 31 by using the transmission resources of zone A 32 and all of zone A's neighboring zones: zone B 33, zone C 34, zone D 35, zone E 36, zone F 37, and zone G 38. In fact, in certain prior systems the MSC would have paged not only the neighboring zones, but every one of its zones. Thus, the systems and methods of the various embodiments of the invention can significantly limit the overburdening of the transmission resources of the multi-zone communication system 11.

In another example in reference to FIG. 3, the MSC when accessing the location register for the second time may only obtain a single zone location for the second zone location. The second zone location thus may have updated with the mobile station's 31 relocating to and registering in zone B 33. Then the MSC would only use the transmission resources of zone B 33 to repage the mobile station 31.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
determining a need to locate a given wireless mobile station with respect to a multi-zone wireless communication system;
in response to determining the need to locate the given wireless mobile station, automatically accessing a location register to obtain a first zone location as corresponds to the given wireless mobile station;
using the first zone location to facilitate sourcing a wireless communication to the given wireless mobile station;
determining that the given wireless mobile station did not respond to the wireless communication;
in response to determining that the given wireless mobile station did not respond to the wireless communication, automatically accessing the location register to obtain a second zone location as corresponds to the given wireless mobile station.

2. The method of claim 1 wherein determining a need to locate a given wireless mobile station with respect to a multi-zone wireless communication system further comprises determining a need to locate a given wireless telephony device with respect to a multi-zone wireless communication system.

3. The method of claim 1 wherein determining a need to locate a given wireless mobile station with respect to a multi-zone wireless communication system further comprises determining a need to locate a given wireless mobile station with respect to a geographically distributed resource reuse wireless communication system.

4. The method of claim 1 wherein automatically accessing a location register to obtain a first zone location as corresponds to the given wireless mobile station further comprises automatically accessing a visited location register to obtain a first zone location as corresponds to the given wireless mobile station.

5. The method of claim 1 wherein automatically accessing a location register to obtain a first zone location as corresponds to the given wireless mobile station further comprises automatically accessing a location register to obtain a first zone location as corresponds to a last known zone location for the given wireless mobile station.

6. The method of claim 1 wherein using the first zone location to facilitate sourcing a wireless communication to the given wireless mobile station further comprises sourcing a wireless transmission to the given wireless mobile station using only transmission resources of a zone that corresponds to the first zone location.

7. The method of claim 1 wherein determining that the given wireless mobile station did not respond to the wireless communication further comprises determining that the given wireless mobile station did not respond to the wireless communication within at least a predetermined period of time.

8. The method of claim 1 wherein automatically accessing the location register to obtain a second zone location as corresponds to the given wireless mobile station further comprises automatically accessing the location register to obtain a second zone location as corresponds to the given wireless mobile station such that updated zone location information may be obtained.

9. The method of claim 1 wherein automatically accessing the location register to obtain a second zone location as corresponds to the given wireless mobile station further comprises automatically accessing the location register to obtain only a single zone location as corresponds to the given wireless mobile station.

10. The method of claim 1 wherein automatically accessing the location register to obtain a second zone location as corresponds to the given wireless mobile station further comprises automatically accessing the location register to obtain a plurality of zone locations as correspond to the given wireless mobile station.

11. The method of claim 11 wherein automatically accessing the location register to obtain a plurality of zone locations as correspond to the given wireless mobile station further comprises accessing the location register to obtain zone locations for some, but not all, zones that are neighbor zones to the first zone location.

12. The method of claim 1 and further comprising:
using the second zone location to facilitate sourcing a subsequent wireless communication to the given wireless mobile station.

13. The method of claim 15 and further comprising:
determining that the given wireless mobile station did not respond to the subsequent wireless communication;
in response to determining that the given wireless mobile station did not respond to the subsequent wireless communication, automatically taking a predetermined action.

14. The method of claim 16 wherein automatically taking a predetermined action further comprises at least one of:
automatically accessing the location register to obtain supplemental zone location as corresponds to the given wireless mobile station;
automatically conclude attempts to facilitate a wireless communication with the given wireless mobile station;
automatically sourcing a subsequent wireless communication to the given wireless mobile station by using transmission resources of all neighbor zones for the second zone location.

15. A method to facilitate determining a present location of a given wireless mobile station in a multi-zone wireless communication system, comprising:
determining a need to locate the given wireless mobile station within the multi-zone wireless communication system;
in response to determining the need to locate the given wireless mobile station, automatically accessing a first location register to obtain a first zone location as corresponds to the given wireless mobile station;
using the first zone location to facilitate sourcing a wireless communication to the given wireless mobile station using only the transmission resources of the first zone location;
determining that the given wireless mobile station did not respond to the wireless communication;
in response to determining that the given wireless mobile station did not respond to the wireless communication, automatically accessing a second location register to obtain a second zone location as corresponds to the given wireless mobile station, which second zone location may be the same as the first zone location;
using the second zone location to facilitate sourcing a wireless communication to the given wireless mobile station using only the transmission resources of the second zone location, such that neighbor zones to the second zone location are not utilized to source a wireless communication to the given wireless mobile station.

16. The method of claim 18 wherein automatically accessing a location register to obtain a first zone location further comprises automatically accessing a visited location register to obtain the first zone location.

17. The method of claim 18 wherein automatically accessing a location register to obtain a second zone location further comprises automatically accessing a visited location register to obtain the second zone location.

18. A system controller for use in a multi-zone wireless communication system comprising:
a location register interface;
a first mode of operation such that a repage communication to a given mobile station is sourced using only transmission resources of a single zone.

19. The system controller of claim 23 further comprising repage means for accessing the location register interface subsequent to an unsuccessful page to the given mobile station to obtain zone location information for a single zone as corresponds to the given mobile station.

20. The system controller of claim 24 wherein the repage means is further for using only the zone location information for a single zone to facilitate a repage transmission to the given mobile station.
